(19) United States
(12) Patent Application Publication
(10) Pub. No.: US 2026/0051692 A1
(43) Pub. Date: Feb. 19, 2026

(54) CONNECTOR

(71) Applicant: HOSIDEN CORPORATION, Osaka (JP)

(72) Inventor: Yuta KAWAKAMI, Osaka (JP)

(21) Appl. No.: 19/281,938

(22) Filed: Jul. 28, 2025

(30) Foreign Application Priority Data
Jul. 29, 2024 (JP) 2024-122475

(51) Int. Cl. H01R 13/52; H01R 13/504

(52) U.S. Cl. CPC H01R 13/5202; H01R 13/5045

(57) ABSTRACT

A connector includes a terminal, a first holder and a second holder that hold the terminal, a shell that holds the first holder and the second holder, and a waterproof member that is disposed in close contact with the terminal and the shell. The terminal has a body portion and a first connection portion, and the waterproof member is fitted onto the body portion. The shell has a partition portion including an insertion hole. The internal space of the shell is partitioned by the partition portion into a connection space and a holder accommodation space. The first connection portion of the terminal extends from the partition portion to the connection space, with the first holder inserted into the insertion hole and at least part of the first connection portion exposed to the connection space. The body portion of the terminal and the waterproof member are disposed in the holder accommodation space.

### CROSS REFERENCE TO RELATED APPLICATION

This application is based on and claims priority under 35 U.S.C. Section 119 to Japanese Patent Application No. 2024-122475 filed on Jul. 29, 2024, the entire content of which is incorporated herein by reference.

### TECHNICAL FIELD

This disclosure relates to a connector.

### RELATED ART

Conventionally, waterproof structures that prevent entry of water or the like from the outside have been known. An example of a technique relating to such a waterproof structure is described in JP 6-60069UM-A.

JP 6-60069UM-A discloses a connector having a waterproof structure. The connector includes a connector shell, a core contact, an O-ring, and a fixing member. The connector shell is formed in one piece with the case and has a through hole formed therein leading to the inside of the case. The core contact is inserted into the connector shell and has a terminal (contact pin in JP 6-60069UM-A) that passes through the through hole and protrudes into the inside of the case, and a contact portion into which the central conductor of the plug connected to this connector is inserted to be electrically connected. The O-ring is inserted into the connector shell with the terminal of the core contact passing through the center, providing a seal between the inside and outside of the case. The fixing member is made of an insulating material, and is press-fitted into and locked to the connector shell to fix the core contact and the O-ring within the connector shell.

In a connector having this waterproof structure, there is no need for a waterproof structure between the connector and the case to which the connector is attached. In addition, the attachment is completed simply by inserting the core contact and the like with the O-ring attached into the connector shell, then press-fitting the fixing member and locking it using a projection formed on the inner wall of the connector shell. Thus, the attachment task can be simplified.

### SUMMARY

In the connector described in JP 6-60069UM-A, if the terminal is thin, the compression rate of the O-ring at the contact portion between the O-ring and the contact pin becomes small, which may make it difficult to ensure a sufficient waterproof structure, leaving room for improvement.

In view of this, there has been demand for a connector having a waterproof structure that can reliably prevent water and the like from entering along the terminal.

One embodiment of a connector according to the present disclosure is a connector including: a rod-shaped terminal made of a conductive material; a cylindrical first holder and a cylindrical second holder that are made of an insulating material and are configured to hold the terminal in such a manner as to be coaxial with an axis of the terminal when the terminal is inserted therein; a cylindrical shell that is made of a conductive material and is configured to hold the first holder and the second holder in such a manner as to be coaxial with the axis when the first holder and the second holder are inserted therein; and a cylindrical waterproof member that is made of an elastic insulating material and disposed in close contact with the terminal and the shell, in which the terminal has a body portion and a first connection portion extending in one direction along the axis from the body portion and having a smaller diameter than the body portion, the waterproof member is fitted onto the body portion, the shell has a partition portion including a partition wall protruding radially inward from an inner circumferential surface of the shell and an insertion hole that is a through hole coaxial with the axis at the center of the partition wall, the partition portion partitions an internal space of the shell into a connection space and a holder accommodation space, the first connection portion of the terminal extends from the partition portion to the connection space, with the first holder inserted into the insertion hole and at least part of the first connection portion exposed to the connection space, and the body portion of the terminal and the waterproof member are disposed in the holder accommodation space.

According to this embodiment, in the connector, the waterproof member is made of an insulating material, is fitted onto the body portion of the terminal, and is in close contact with the terminal and the shell. With this configuration, water or the like that has entered from the connection space can be prevented from entering the second holder through a gap between the second holder and the inner circumferential surface of the shell and a gap between the first holder and the terminal. In addition, since the body portion of the terminal has a larger diameter than the first connection portion, the inner diameter of the cylindrical waterproof member can be made large, thereby making it possible to increase the radial elastic deformation rate of the waterproof member at the contact portion between the waterproof member and the body portion of the terminal, and maintain sufficient waterproof characteristics. Thus, it was possible to realize a connector having a waterproof structure that can reliably prevent water or the like from entering along the terminal.

In another embodiment of the connector according to the present disclosure, the terminal has a second connection portion that is disposed opposite to the first connection portion with respect to the body portion, extends in another direction along the axis from the body portion, and has a smaller diameter than the body portion, the first holder is fixed in close contact with the body portion and the first connection portion, and the second holder is fixed in close contact with the body portion and the second connection portion.

According to this embodiment, the first holder is fixed in close contact with the body portion and the first connection portion, and the second holder is fixed in close contact with the body portion and the second connection portion. Also, the body portion is disposed between the first connection portion and the second connection portion. Since the body portion is exposed between the first holder and the second holder, a single waterproof member can be used to seal the gap between the terminal and the first holder and the gap between the shell and the second holder, thereby obtaining a waterproof structure. This makes it possible to more reliably prevent water or the like that has entered from the connection space from entering the second holder through a gap between the second holder and the inner circumferential surface of the shell, and a gap between the first holder and the terminal.

In another embodiment of the connector according to the present disclosure, an outer diameter of the first holder is less than or equal to an outer diameter of the body portion of the terminal.

According to this embodiment, the waterproof member can be easily fitted onto the body portion of the terminal.

In another embodiment of the connector according to the present disclosure, the terminal is held by the first holder and the second holder, at least one of which is formed by insert molding.

According to this embodiment, in the step of manufacturing the connector, it is possible to eliminate the step of inserting the terminal into the first holder and the second holder and attaching the terminal thereto, compared to the case where the terminal and the first holder and second holder are produced separately and then attached. This makes it possible to reduce the cost of the connector.

In another embodiment of the connector according to the present disclosure, the inner circumferential surface of the partition wall in which the insertion hole is formed has an enlarged diameter at a corner closer to the body portion of the terminal due to a cutout portion that is cut out over the entire circumference.

According to this embodiment, when the first holder and the terminal are inserted into the shell, the leading end of the first connection portion of the terminal is guided into the insertion hole along the cutout portion, and therefore the first terminal portion can be easily inserted into the insertion hole. In addition, the insulation distance (clearance distance and creepage distance) between the partition portion of the shell and the body portion of the terminal can be increased, making it possible to reliably prevent aerial discharge and dielectric breakdown (short-circuiting) between the shell and the terminal.

In another embodiment of the connector according to the present disclosure, at least part of the waterproof member overlaps with the first holder in a view of the waterproof member in a radial direction.

According to this embodiment, the insulation distance (clearance distance and creepage distance) between the partition portion of the shell and the body portion of the terminal can be further increased, making it possible to more reliably prevent aerial discharge and dielectric breakdown between the shell and the terminal.

### BRIEF DESCRIPTION OF DRAWINGS

FIG. 1 is an exploded perspective view of a connector.

FIG. 2 is an exploded perspective view of the connector.

FIG. 3 is a partial vertical cross-sectional view and a partial enlarged view of the connector.

### DESCRIPTION OF EMBODIMENTS

Hereinafter, an embodiment of a connector according to the present disclosure will be described in detail with reference to the drawings. Note that the embodiments described hereinafter are examples for describing the connector according to the present disclosure, and the connector is not limited only to these embodiments. Accordingly, the connector according to the present disclosure can be implemented in various forms without departing from the spirit thereof.

### Configuration of Connector

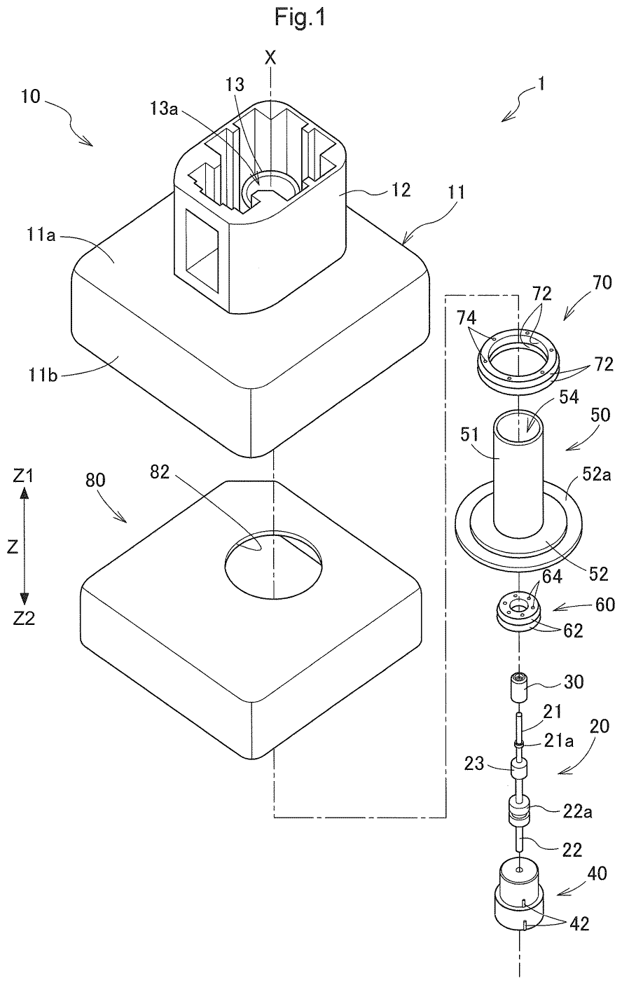

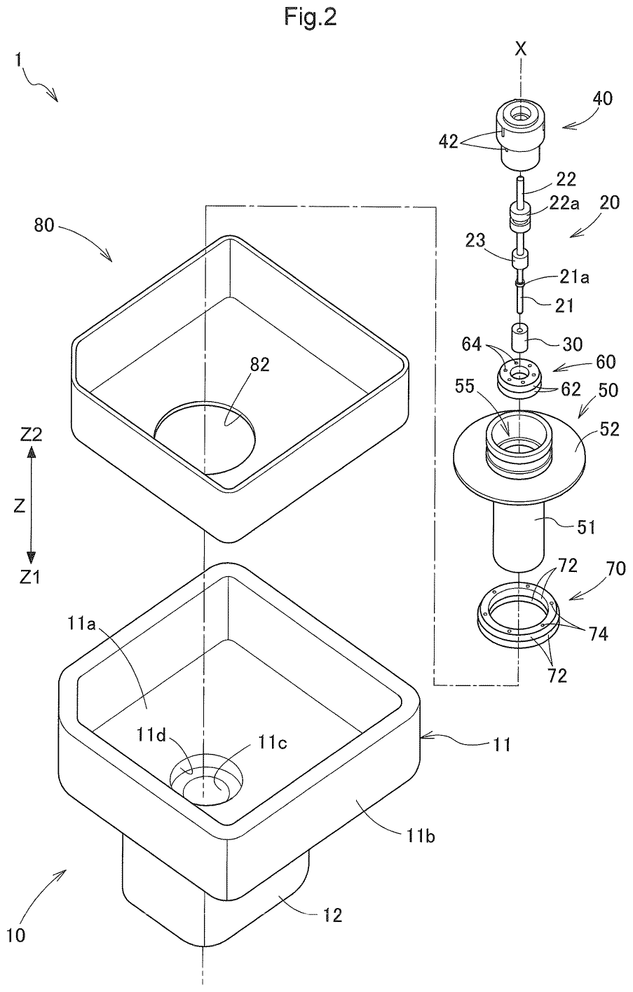

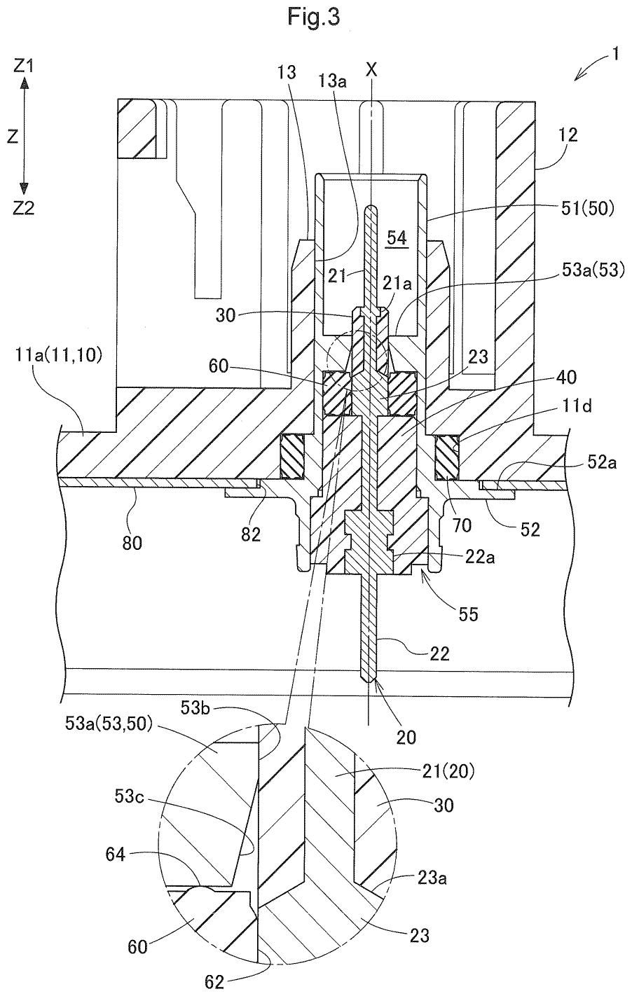

A connector 1 according to this embodiment will be described with reference to FIGS. 1 to 3. FIGS. 1 and 2 are exploded perspective views of the connector 1. FIG. 3 is a partial vertical cross-sectional view and a partial enlarged view of the connector 1.

As shown in FIGS. 1 and 2, the connector 1 in this embodiment is configured as a receptacle connector, and includes a housing 10, a terminal 20, a first holder 30, a second holder 40, a shell 50, a first gasket 60 (an example of a waterproof member), a second gasket 70, and a shield case 80.

The terminal 20 has a circular cross-section and is rod-shaped. In FIGS. 1 to 3, the direction along an axis X passing through the center of the cross-section of the terminal 20 is defined as the Z direction. As shown in FIG. 3, the direction or side of the first holder 30 relative to the second holder 40 is defined as the Z1 direction (an example of one direction) or the Z1 side. Similarly, the direction or side of the second holder 40 relative to the first holder 30 is defined as the Z2 direction (an example of another direction) or the Z2 side.

The housing 10 corresponds to a housing of a receptacle connector. The housing 10 includes a base portion 11, a connection portion 12, and a shell insertion portion 13. In this embodiment, the base portion 11 has a pentagonal shape in a view along the Z direction (hereinafter also referred to as a plan view). The base portion 11 has a plate-shaped top plate portion 11a and a wall portion 11b standing upright in the Z2 direction from the top plate portion 11a. The inside surrounded by the top plate portion 11a and the wall portion 11b is a hollow space. The surface on the Z2 side of the top plate portion 11a of the base portion 11 is provided with a through hole 11c that is in communication with a later-described shell accommodation space 13a. In addition, a gasket accommodation portion 11d, which is an annular groove in which the second gasket 70 is accommodated, is formed around the through hole 11c so as to be coaxial with the through hole 11c.

The connection portion 12 extends from the top plate portion 11a of the base portion 11 in the Z1 direction, which is the opposite direction to the wall portion 11b. The outer shape of the connection portion 12 is smaller than the outer shape of the base portion 11, and the connection portion 12 is formed in one piece with the base portion 11 while placed on the base portion 11. As shown in FIGS. 1 and 3, the shell insertion portion 13 is disposed in the space inside the connection portion 12 and is formed in a cylindrical shape. The axis of the shell insertion portion 13 is coaxial with the axis X. The shell accommodation space 13a is formed radially inward of the shell insertion portion 13. The shell accommodation space 13a is a hollow space.

In this embodiment, the housing 10 is made of an insulating material such as resin, but it may be made of a metal material. In addition, the housing 10 may be made of an insulating material, and its outer surface may be covered with a metal material by plating or vapor deposition.

The shell 50 is formed into a cylindrical shape from a conductive material such as iron, copper, aluminum, or another metal, and at least part of the shell 50 is accommodated in the shell accommodation space 13a of the housing 10. As shown in FIGS. 1 and 3, the shell 50 has a tubular portion 51 extending along the axial direction Z, and a flange portion 52 that has a circular outer shape in a plan view and protrudes radially outward from the outer circumferential surface near the end on the Z2 side of the tubular portion 51. The axes of the tubular portion 51 and the flange portion 52 are coaxial with the axis X. A recess 52a that is more recessed toward the Z2 side than a radially inward portion is formed near the outer edge of the flange portion 52.

A partition portion 53 is formed in the internal space of the tubular portion 51 on the Z1 side relative to the flange portion 52 of the shell 50. The partition portion 53 has a partition wall 53a protruding radially inward from the inner circumferential surface of the tubular portion 51, and an insertion hole 53b, which is a through hole having a circular cross-section and is formed in the center of the partition wall 53a. The axis of the insertion hole 53b is coaxial with the axis X. At a corner on the Z2 side of the inner circumferential surface of the insertion hole 53b of the partition portion 53, a cutout portion 53c is formed that is cut obliquely with respect to the Z direction over the entire circumference. Due to the cutout portion 53c, the inner diameter of the inner circumferential surface of the insertion hole 53b increases along the Z2 direction.

The internal space of the tubular portion 51 of the shell 50 is partitioned into two internal spaces by a partition portion 53. Of the two partitioned internal spaces, the internal space on the Z1 side of the partition portion 53 is referred to as a connection space 54, and the internal space on the Z2 side of the partition portion 53 is referred to as a holder accommodation space 55. The connection space 54 and the holder accommodation space 55 are connected to each other via the insertion hole 53b.

The shell 50 can be formed by cutting using a lathe or the like. This makes it possible to easily form the tubular portion 51, the flange portion 52, and the insertion hole 53b coaxially. In addition, when the shell 50 is formed by cutting, the characteristic impedance of the connector 1, which is determined by the material characteristics and shapes of the first holder 30 and the second holder 40, the shape of the terminal 20, the distance between the shell 50 and the terminal 20, and the like can be easily adjusted (i.e., while maintaining coaxiality). In addition, if the shell 50 is formed through sheet metal machining, there is a risk that noise will be radiated from the locations that are joined to form the tubular shape, degrading the EMC characteristics. However, if the shell is formed by cutting, it can be formed without including joints that radiate noise that degrades the EMC characteristics, which is advantageous in terms of the EMC characteristics.

The terminal 20 is a rod-shaped member with a circular cross-section made of a conductive material such as iron, copper, or aluminum. The terminal 20 extends from the connection space 54 of the shell 50 to the holder accommodation space 55, with its axis X extending along the Z direction. The terminal 20 has a first connection portion 21, a second connection portion 22, and a body portion 23. The first connection portion 21 extends from the body portion 23 in the Z1 direction, and the second connection portion 22 extends from the body portion 23 in the Z2 direction. That is, the second connection portion 22 is disposed opposite to the first connection portion 21 with respect to the body portion 23. The outer diameters of the first connection portion 21 and the second connection portion 22 are approximately the same, but may be different, and the outer diameters of the first connection portion 21 and the second connection portion 22 are smaller than the outer diameter of the body portion 23. The terminal 20 is formed by cutting using a lathe or the like.

The first connection portion 21 extends from the insertion hole 53b of the partition portion 53 to the connection space 54 of the shell 50. The body portion 23 is disposed in the holder accommodation space 55, and the second connection portion 22 is at least partially disposed in the holder accommodation space 55. The first connection portion 21 is provided with a first holder fixing portion 21a for fixing the first holder 30, and the second connection portion 22 is provided with a second holder fixing portion 22a for fixing the second holder 40. The first holder fixing portion 21a is formed approximately in the middle in the Z direction of the first connection portion 21 in such a manner as to protrude radially outward. The second holder fixing portion 22a is formed approximately in the middle in the Z direction of the second connection portion 22 in such a manner as to protrude radially outward.

The body portion 23 has, at the boundary with the first connection portion 21, an inclined surface 23a that is inclined toward the Z2 direction as it extends radially outward (see the enlarged view of FIG. 3).

The first holder 30 is formed by insert molding to be in close contact with the outer circumferential surface of the first connection portion 21 of the terminal 20. That is, the terminal 20 is partially inserted into the first holder 30. The first holder 30 is made of an insulating material such as resin. The first holder 30 is formed along the Z direction from the boundary with the body portion 23 to the end surface on the Z1 side of the first holder fixing portion 21a. The outer diameter of the first holder 30 is less than or equal to the outer diameter of the body portion 23 of the terminal 20, and is approximately the same as the inner diameter of the insertion hole 53b of the partition portion 53 of the shell 50.

Since at least part of the first holder 30 is disposed in the connection space 54, when a connector that is a fitting partner of the connector 1 is inserted into the connection space 54 to be connected to the connector 1, the outer conductor of the connector that is the fitting partner is guided by the first holder 30 to be disposed coaxially with the axis X of the connector 1. This makes it possible to prevent a decrease in coaxiality and to prevent deterioration of transmission characteristics and EMC characteristics.

The second holder 40 is formed by insert molding at the same time as the first holder 30, in such a manner as to be in close contact with the outer circumferential surface of the second connection portion 22 of the terminal 20. That is, the terminal 20 is partially inserted into the second holder 40. The second holder 40 is made of the same insulating material as the first holder 30. The second holder 40 is formed along the Z direction from the boundary with the body portion 23 to the end surface on the Z2 side of the second holder fixing portion 22a. The outer diameter of the second holder 40 is approximately the same as the inner diameter of the tubular portion 51 that defines the holder accommodation space 55 of the shell 50, and has a shape that follows the shape of the inner circumferential surface of the tubular portion 51 that defines the holder accommodation space 55. A plurality of protrusions 42 that are to become press-fitting portions when inserted into the shell 50 are arranged at equal intervals along the circumferential direction on the outer circumferential surface of the second holder 40. Note that the first holder 30 and the second holder 40 are formed apart from each other and are not connected to each other. In addition, the axes of the first holder 30 and the second holder 40 are coaxial with the axis X.

The first gasket 60 is a cylindrical component made of an elastic insulating material such as rubber. The first gasket 60 is fitted onto the body portion 23 of the terminal 20, and its outer circumferential surface is at the inner circumferential surface of the tubular portion 51 of the shell 50. When fitted onto the body portion 23, the inner diameter of the first gasket 60 expands due to elastic deformation and comes into close contact with the outer circumferential surface of the body portion 23. In addition, when fitted inside the tubular portion 51 of the shell 50, the outer diameter of the first gasket 60 contracts due to elastic deformation and comes into close contact with the inner circumferential surface of the tubular portion 51 that defines the holder accommodation space 55. The first gasket 60 has a plurality (two in this embodiment) of annular first protruding rings 62 formed on each of its inner and outer circumferential surfaces, and a plurality (six in this embodiment) of first projections 64 are formed on each of its upper and lower surfaces (see FIG. 3). Since the first gasket 60 has the first protruding rings 62, the contact area during close contact is reduced, making it possible to increase the contact pressure. The first gasket 60 ensures waterproofing using the plurality of first protruding rings 62 formed on both the inner and outer circumferential surfaces. The plurality of first projections 64 are intended to prevent the degree of close contact in the Z direction from becoming uneven, which causes the radial compression rate of the first protruding rings 62 to become uneven depending on the location. As a result, favorable waterproofing can be achieved. Note that the first gasket 60 is not limited to a cylindrical shape, and may be, for example, an annular component such as an O-ring.

The second gasket 70 is a cylindrical component made of an elastic insulating material such as rubber. Similarly to the first gasket 60, the second gasket 70 has a plurality (two in this embodiment) of annular second protruding rings 72 formed on each of its inner and outer circumferential surfaces, and a plurality (six in this embodiment) of second projections 74 formed on each of its upper and lower surfaces. The second gasket 70 is fitted onto the tubular portion 51 of the shell 50. Since the second gasket 70 has the second protruding rings 72, the contact area during close contact is reduced, making it possible to increase the contact pressure. The second gasket 70 ensures waterproofing using the plurality of second protruding rings 72 formed on both the inner and outer circumferential surfaces. The plurality of second projections 74 are intended to prevent the degree of close contact in the Z direction from becoming uneven, which causes the radial compression rate of the second protruding rings 72 to become uneven depending on the location. As a result, favorable waterproofing can be achieved. Note that the second gasket 70 is not limited to a cylindrical shape, and may be, for example, an annular component such as an O-ring.

The shield case 80 is made of a conductive material such as iron or aluminum, and has a shape and size that allows it to be in close contact with the inner surfaces of the top plate portion 11a and the wall portion 11b of the base portion 11. The shield case 80 is provided with an opening 82 that is coaxial with the axis of the through hole 11c provided in the top plate portion 11a of the base portion 11 and has an inner diameter larger than the inner diameter of the gasket accommodation portion 11d. Note that as long as the shield case 80 is at least partially accommodated in the base portion 11, it is not necessary for the shield case 80 to be in close contact with the inner surfaces of the top plate portion 11a and the wall portion 11b.

Note that the connector 1 may be, for example, a coaxial connector in which the shell 50 serves as a coaxial shield and the terminal 20 serves as a center pin. If the connector 1 is a coaxial connector, the characteristic impedance of the terminal 20 can be controlled by adjusting the outer diameter of the body portion 23. That is, part of the first connection portion 21 is exposed from the first holder 30, and the characteristic impedance of this part becomes large. This is because the relative dielectric constant of the insulating material that constitutes the first holder 30 is smaller than the relative dielectric constant of air. However, when the outer diameter of the body portion 23 is increased, the characteristic impedance of the body portion 23 is reduced, and therefore the characteristic impedance of the first connection portion 21 can be suppressed from increasing. This makes it possible to adjust the impedance of the connector 1, thereby achieving a coaxial connector with favorable transmission characteristics.

### Connector Manufacturing Method

Next, a method for manufacturing the connector 1 will be described. First, the terminal 20 machined into the above-mentioned shape by cutting is placed in a mold, and the first holder 30 and the second holder 40 are molded into the above-mentioned shape by insert molding. As a result, the first holder 30 is fixed in close contact with the body portion 23 and the first connection portion 21. In addition, the second holder 40 is fixed in close contact with the body portion 23 and the second connection portion 22. Then, the first gasket 60 is inserted from the side of the first connection portion 21 of the terminal 20 and fitted onto the body portion 23. Since the outer diameter of the first holder 30 is less than or equal to the outer diameter of the body portion 23 of the terminal 20, the first gasket 60 can be inserted through the first holder 30 and fitted onto the body portion 23. When fitted onto the body portion 23, the inner circumferential surface of the first gasket 60 elastically deforms and expands in diameter, and the first protruding rings 62 on the inner circumferential surface of the first gasket 60 come into close contact with the body portion 23. The first gasket 60 is inserted until the first projections 64 on one surface abut against the second holder 40. At this time, as shown in the partial enlarged view of FIG. 3, at least part of the first gasket 60 and the first holder 30 overlap with each other in a view along a radial direction perpendicular to the axis X. Hereinafter, the terminal 20 with the first holder 30, the second holder 40, and the first gasket 60 attached thereto will be referred to as a “terminal assembly”.

Next, the terminal assembly is press-fitted into the holder accommodation space 55 of the shell 50 from the Z2 side toward the Z1 side. There is a level difference on the inner circumferential surface of the holder accommodation space 55, and there is also a corresponding level difference in the second holder 40. Therefore, the terminal assembly is press-fitted until the level difference in the second holder 40 abuts against the level difference in the holder accommodation space 55. By press-fitting, the protrusions 42 formed on the outer circumferential surface of the second holder 40 are pressed against the inner circumferential surface of the holder accommodation space 55 and are crushed. As a result, the first holder 30 and the second holder 40 are inserted into the shell 50 and the terminal assembly is fixed to the shell 50. At this time, the first connection portion 21 of the terminal 20 and the first holder 30 are guided by the cutout portion 53c of the partition portion 53 of the shell 50, and can be easily inserted through the insertion hole 53b.

When the press-fitting is complete, the outer circumferential surface of the first gasket 60 of the terminal assembly elastically deforms and contracts in diameter, and the first protruding rings 62 on the outer circumferential surface of the first gasket 60 are in close contact with the inner circumferential surface of the holder accommodation space 55. In addition, the first projections 64 on the other surface of the first gasket 60 are in close contact with or close to the partition wall 53a of the partition portion 53. That is, the first gasket 60 is elastically deformed and disposed in the holder accommodation space 55 while in close contact with or near the outer circumferential surface of the body portion 23 of the terminal 20, the inner circumferential surface of the holder accommodation space 55 of the shell 50, the partition wall 53a, and the second holder 40.

When the press-fitting is complete, the first connection portion 21 of the terminal 20 and the first holder 30 pass through the insertion hole 53b of the partition portion 53, and at least part of the first connection portion 21 and the first holder 30 is exposed to the connection space 54. That is, the first connection portion 21 and the first holder 30 extend from the partition portion 53 to the connection space 54. The leading end of the first connection portion 21 and the leading end of the first holder 30 are located within the connection space 54. At this time, the holder accommodation space 55 is filled with the second connection portion 22 and the body portion 23 of the terminal 20, the second holder 40, and the first gasket 60, with almost no gaps. The leading end of the second connection portion 22 protrudes toward the Z2 side relative to the shell 50, and is located within the space inside the base portion 11 of the housing 10.

Next, the second gasket 70 is inserted from the Z1 side toward the Z2 direction. The second gasket 70 is fitted onto the tubular portion 51. At this time, the inner circumferential surface of the second gasket 70 is elastically deformed and expands in diameter, and the second protruding rings 72 on the inner circumferential surface of the second gasket 70 come into close contact with the outer circumferential surface of the tubular portion 51. The second gasket 70 is inserted until the second projections 74 on one surface abut against the flange portion 52. Hereinafter, the terminal assembly press-fitted into the shell 50 with the second gasket 70 fitted thereon will be referred to as a “shell assembly”.

Next, the shield case 80 is attached to the inner surfaces of the top plate portion 11a and the wall portion 11b of the base portion 11 of the housing 10. In this state, the shell assembly is inserted in the Z1 direction in such a manner that the tubular portion 51 of the shell 50 is inserted into the shell accommodation space 13a of the shell insertion portion 13 from the side opposite to the side of the housing 10 where the connection portion 12 is formed. The shell assembly is inserted until the flange portion 52 of shell 50 abuts against the surface on the Z2 side of the top plate portion 11a of the base portion 11 of the housing 10.

At this time, the outer circumferential surface of the tubular portion 51 of the shell 50 of the shell assembly is press-fitted into the inner circumferential surface of the shell insertion portion 13. In addition, the outer circumferential surface of the second gasket 70 elastically deforms and contracts in diameter, whereby the second protruding rings 72 on the outer circumferential surface of the second gasket 70 come into close contact with the inner circumferential surface of the gasket accommodation portion 11d of the base portion 11, and the second projections 74 on the other surface abut against the bottom surface of the gasket accommodation portion 11d. That is, the second gasket 70 is in close contact with or near the outer circumferential surface of the tubular portion 51 and the flange portion 52 of the shell 50 and the inner circumferential surface and bottom surface of the gasket accommodation portion 11d of the base portion 11 of the housing 10 due to elastic deformation. At this time, the radially outward portion of the opening 82 of the shield case 80 fits into the recess 52a of the flange portion 52 and is electrically connected to the shell 50, and as a result of electrical connection between the shell 50 and the shield case 80, the space inside the base portion 11 of the housing 10 is electromagnetically shielded from the space outside. The shield case 80 is held by being sandwiched between the surface on the Z2 side of the top plate portion 11a of the base portion 11 and the recess 52a. This completes the connector 1.

In the connector 1 of this embodiment, as shown in the partial enlarged view of FIG. 3, the cutout portion 53c is formed in the inner circumferential surface of the insertion hole 53b of the partition portion 53 of the shell 50. This makes it possible to easily insert the first connection portion 21 of the terminal 20 and the first holder 30 into the insertion hole 53b, and increases the insulation distance (clearance distance and creepage distance) between the partition portion 53 of the shell 50 and the body portion 23 of the terminal 20, thereby preventing aerial discharge and dielectric breakdown (short-circuiting) between the shell 50 and the terminal 20. In addition, in a view along a radial direction perpendicular to the axis X, at least part of the first gasket 60 overlaps with the first holder 30, and therefore the insulation distance between the partition portion 53 and the body portion 23 is further increased, making it possible to prevent aerial discharge and dielectric breakdown between the shell 50 and the terminal 20.

In the connector 1 of this embodiment, the first gasket 60 is made of an insulating material, is radially shrinkable, and has a deformable cross-sectional shape. The first gasket 60 is fitted onto the body portion 23 of the terminal 20 and is sandwiched between the inner circumferential surface of the tubular portion 51 of the shell 50 and the body portion 23. When the first gasket 60 is sandwiched between the inner circumferential surface of the tubular portion 51 and the body portion 23 in this manner, water or the like that has entered from the connection space 54 can be prevented from entering the Z2 side of the second holder 40 from the gap between the second holder 40 and the inner surface of the tubular portion 51 of the shell 50, and from the gap between the second holder 40 and the terminal 20. In addition, since the body portion 23 of the terminal 20 has a larger diameter than the first connection portion 21, the inner diameter of the cylindrical first gasket 60 can be made larger. Therefore, it is possible to increase the radial elastic deformation rate of the first gasket 60 at the contact portion between the first gasket 60 and the body portion 23 of the terminal 20, and thereby maintain sufficient waterproof characteristics.

The above-described connector 1 can be used, for example, in a vehicle to transmit image signals and audio signals. Such a connector 1 can configure a system for inputting and outputting signals between an electronic device and the outside via a coaxial cable, and can therefore be used in a system for transmitting high-frequency signals and high-speed digital signals. For example, it can be used in an in-vehicle camera system that transmits high-definition video signals. Furthermore, since the connector 1 can be configured compactly, it can be mounted on a board provided in, for example, an electronic device. In this case, the connector 1 can be used as a board connector, and a coaxial cable can be connected to the board via the connector 1. By connecting such a coaxial cable, the connector 1 can be used for transmitting image signals and audio signals, supplying power, and the like.

### Other Embodiments

(1) In the above-described embodiment, the connector 1 has the shield case 80. However, the connector 1 may also be configured without using the shield case 80.
(2) In the above-described embodiment, the connector 1 has one terminal 20. However, the connector 1 may also be a multi-pole connector having a plurality of terminals 20. The connector 1 may also be one of a plurality of connectors 1 provided in an electronic device.
(3) In the above-described embodiment, the housing 10 was described as including the base portion 11 having a pentagonal shape in a plan view and the connection portion 12 formed in one piece with the base portion 11. However, the base portion 11 and the connection portion 12 can also be configured in other shapes, and the housing 10 can also be configured with only the connection portion 12.
(4) In the above-described embodiment, the body portion 23 of the terminal 20 has the inclined surface 23a. However, the body portion 23 may also have a surface perpendicular to the axis X without having the inclined surface 23a. In this case as well, by overlapping at least part of the first gasket 60 with the first holder 30 in a view along a radial direction perpendicular to the axis X, an insulation distance between the partition portion 53 and the body portion 23 can be ensured, thereby making it possible to prevent aerial discharge and dielectric breakdown between the shell 50 and the terminal 20.
(5) In the above-described embodiment, the first gasket 60 and the second gasket 70 have protruding rings and projections. However, the first gasket 60 and the second gasket 70 may also be configured not to have these and to be in contact with each other through surfaces.
(6) The connector 1 of the above-described embodiment can be a board-mounted connector. In this case, the housing 10 may also have a self-supporting shape for mounting vertically or horizontally on a board (not shown) as a housing for a board-mounted connector.
(7) The connector 1 of the above-described embodiment can be a cable assembly connector. In this case, the housing 10 may also have, as a housing for a cable assembly connector, a structure that holds a cable assembly obtained by connecting a cable to the second connection portion 22, and that fits together with and holds a connector that is a fitting partner.

1. A connector comprising:
a rod-shaped terminal made of a conductive material;
a cylindrical first holder and a cylindrical second holder that are made of an insulating material and are configured to hold the terminal in such a manner as to be coaxial with an axis of the terminal when the terminal is inserted therein;
a cylindrical shell that is made of a conductive material and is configured to hold the first holder and the second holder in such a manner as to be coaxial with the axis when the first holder and the second holder are inserted therein; and
a cylindrical waterproof member that is made of an elastic insulating material and disposed in close contact with the terminal and the shell,
wherein the terminal has a body portion and a first connection portion extending in one direction along the axis from the body portion and having a smaller diameter than the body portion,
the waterproof member is fitted onto the body portion,
the shell has a partition portion including a partition wall protruding radially inward from an inner circumferential surface of the shell and an insertion hole that is a through hole coaxial with the axis at the center of the partition wall,
the partition portion partitions an internal space of the shell into a connection space and a holder accommodation space,
the first connection portion of the terminal extends from the partition portion to the connection space, with the first holder inserted into the insertion hole and at least part of the first connection portion exposed to the connection space, and
the body portion of the terminal and the waterproof member are disposed in the holder accommodation space.

2. The connector according to claim 1,
wherein the terminal has a second connection portion that is disposed opposite to the first connection portion with respect to the body portion, extends in another direction along the axis from the body portion, and has a smaller diameter than the body portion,
the first holder is fixed in close contact with the body portion and the first connection portion, and
the second holder is fixed in close contact with the body portion and the second connection portion.

3. The connector according to claim 1, wherein an outer diameter of the first holder is less than or equal to an outer diameter of the body portion of the terminal.

4. The connector according to claim 2, wherein an outer diameter of the first holder is less than or equal to an outer diameter of the body portion of the terminal.

5. The connector according to claim 1, wherein the terminal is held by the first holder and the second holder, at least one of which is formed by insert molding.

6. The connector according to claim 2, wherein the terminal is held by the first holder and the second holder, at least one of which is formed by insert molding.

7. The connector according to claim 3, wherein the terminal is held by the first holder and the second holder, at least one of which is formed by insert molding.

8. The connector according to claim 4, wherein the terminal is held by the first holder and the second holder, at least one of which is formed by insert molding.

9. The connector according to claim 1, wherein the inner circumferential surface of the partition wall in which the insertion hole is formed has an enlarged diameter at a corner closer to the body portion of the terminal due to a cutout portion that is cut out over the entire circumference.

10. The connector according to claim 2, wherein the inner circumferential surface of the partition wall in which the insertion hole is formed has an enlarged diameter at a corner closer to the body portion of the terminal due to a cutout portion that is cut out over the entire circumference.

11. The connector according to claim 3, wherein the inner circumferential surface of the partition wall in which the insertion hole is formed has an enlarged diameter at a corner closer to the body portion of the terminal due to a cutout portion that is cut out over the entire circumference.

12. The connector according to claim 4, wherein the inner circumferential surface of the partition wall in which the insertion hole is formed has an enlarged diameter at a corner closer to the body portion of the terminal due to a cutout portion that is cut out over the entire circumference.

13. The connector according to claim 5, wherein the inner circumferential surface of the partition wall in which the insertion hole is formed has an enlarged diameter at a corner closer to the body portion of the terminal due to a cutout portion that is cut out over the entire circumference.

14. The connector according to claim 1, wherein at least part of the waterproof member overlaps with the first holder in a view of the waterproof member in a radial direction.

15. The connector according to claim 2, wherein at least part of the waterproof member overlaps with the first holder in a view of the waterproof member in a radial direction.

16. The connector according to claim 3, wherein at least part of the waterproof member overlaps with the first holder in a view of the waterproof member in a radial direction.

17. The connector according to claim 5, wherein at least part of the waterproof member overlaps with the first holder in a view of the waterproof member in a radial direction.

18. The connector according to claim 6, wherein at least part of the waterproof member overlaps with the first holder in a view of the waterproof member in a radial direction.

19. The connector according to claim 9, wherein at least part of the waterproof member overlaps with the first holder in a view of the waterproof member in a radial direction.

20. The connector according to claim 10, wherein at least part of the waterproof member overlaps with the first holder in a view of the waterproof member in a radial direction.
